(19) United States
(12) Patent Application Publication
(10) Pub. No.: US 2025/0175676 A1
(43) Pub. Date: May 29, 2025

(54) VIRTUAL REALITY-BASED VIDEO PLAYBACK METHOD AND APPARATUS, AND ELECTRONIC DEVICE

(71) Applicant: Beijing Zitiao Network Technology Co., Ltd., Beijing (CN)

(72) Inventors: Liyue JI, Beijing (CN); Dongyang ZHAO, Beijing (CN); Xinkai ZHOU, Beijing (CN); Xiaolin LI, Beijing (CN)

(21) Appl. No.: 18/839,705

(22) PCT Filed: Feb. 20, 2023
(86) PCT No.: PCT/CN2023/077230

§ 371 Date: Aug. 19, 2024

(30) Foreign Application Priority Data
Mar. 2, 2022 (CN) 202210199057.3

(51) Int. Cl. H04N 21/472; H04N 21/431; H04N 21/442; H04N 21/45

(52) U.S. Cl. CPC H04N 21/47202; H04N 21/431; H04N 21/44218; H04N 21/4532

(57) ABSTRACT

The disclosure relates to a method, an apparatus, and an electronic device of video playback based on virtual reality, which relate to the field of virtual reality technology. The method includes: first, obtaining focus information of a user; determining, based on the focus information, a first video cover that meets a predetermined preview condition in a list of video covers; then obtaining a first predetermined video segment of the first video cover; and then playing the first predetermined video segment in a panoramic space of virtual reality. By applying the technical solution of the disclosure, the selection time spent by the user for video-on-demand during the use of the virtual reality device can be reduced, which saves the operational cost for the user during the virtual reality experience, and thus improving the efficiency of the user in watching a video that meets his or her need.

### CROSS REFERENCE

This application claims priority to Chinese Patent Application No. 202210199057.3, filed on Mar. 2, 2022, and entitled “VIRTUAL REALITY-BASED VIDEO PLAYBACK METHOD AND APPARATUS, AND ELECTRONIC DEVICE”, the entirety of which is incorporated herein by reference.

### FIELD

The present disclosure relates to the field of virtual reality technology, and in particular, to a method, an apparatus, and an electronic device of video playback based on virtual reality.

### BACKGROUND

With the development of Virtual Reality (VR) technology, an increasing number of users watch videos through various VR devices. The authenticity of the simulation environment makes it difficult to distinguish from the real world, giving users a feeling of being fully immersed.

In the process of watching videos by uses using VR devices, to facilitate video-on-demand, at present, a content list is available. Such a content list includes covers of a plurality of videos Users may select to play a target video from the content list based on the introductions of the video covers.

However, the content display of the video cover is limited, making it difficult for users to quickly understand specific video-related content and the VR effect after the video is played, which in turn increases the time the users take to select a video on-demand, and thus affecting the operational cost of the users during the VR experience.

### SUMMARY

In view of above, the present disclosure provides a method, an apparatus and an electronic device of video playback based on virtual reality, mainly aimed at solving the technical problem that the selection time spent by users for video-on-demand is increased in prior art, which affects the operational cost of the users during the virtual reality experience.

In a first aspect, the present disclosure provides a method of video playback based on virtual reality. comprising:
obtaining user focus information;
determining, based on the focus information, a first video cover that meets a predetermined preview condition in a list of video covers;
obtaining a first predetermined video segment of the first video cover;
playing the first predetermined video segment in a panoramic space of virtual reality.

In a second aspect, the present disclosure provides an apparatus of video playback based on virtual reality, comprising:
an obtaining module configured to obtain focus information of a user;
a determination module configured to determine, based on the focus information, a first video cover that meets a predetermined preview condition in a list of video covers;
the obtaining module further configured to obtain a first predetermined video segment of the first video cover;
a playback module configured to play the first predetermined video segment in a panoramic space of virtual reality.

In a third aspect, the present disclosure provides a computer-readable storage medium having a computer program stored thereon, wherein the computer program, when executed by a processor, carries out the method of video playback based on virtual reality as described in the first aspect.

In a fourth aspect, the present disclosure provides an electronic device comprising a storage medium, a processor, and a computer program stored on the storage medium and runnable on the processor, wherein the processor, when executing the computer program, carries out the method of video playback based on virtual reality as described in the first aspect.

By means of the above technical solution, the present disclosure provides a method, an apparatus, and an electronic device of video playback based on virtual reality. Compared with the present prior art, the present disclosure can provide more reference information during the user selects the contents of the list of video covers, which helps the user promptly understand the specific video-related content corresponding to the video cover and the virtual reality effect after the video is played. Specifically, on the side of the VR device, a video cover that meets the predetermined preview condition can be determined in the list of video covers based on the user's focus, and then the predetermined video segment of the video cover is played in the panoramic space of virtual reality. By applying the technical solution of the present disclosure, the selection time spent by the user for video-on-demand when using the VR device can be reduced, which saves the operational cost for the user during the VR experience, thereby improving the efficiency of the user to watch the video that meet his or her need.

The above description is merely an overview of the technical solution of the present disclosure. To clearly understand the technical means of the present disclosure and to implement them according to the contents of the specification, and to make the above and other objectives, features, and advantages of the present disclosure more apparent and easier to understand, specific embodiments of the present disclosure are provided below.

### BRIEF DESCRIPTION OF THE DRAWINGS

The accompanying drawings, which are incorporated in and form a part of the specification, illustrate embodiments according to the present disclosure, and together with the specification, serve to explain the principles of the present disclosure.

To clearly illustrate the embodiments of the present disclosure or the technical solutions in the prior art, the accompanying drawings used in the description of the embodiments or the prior art will be briefly described below. It is apparent to those skilled in the art that other accompanying drawings can be acquired based on these accompanying drawings without creative efforts.

FIG. 1 illustrates a flowchart of a method of video playback based on virtual reality according to embodiments of the present disclosure.

FIG. 2 illustrates a flowchart of another method of video playback based on virtual reality according to embodiments of the present disclosure.

FIG. 3 illustrates a schematic diagram of an example display effect of a list of video covers according to embodiments of the present disclosure.

FIG. 4 illustrates a schematic diagram of an example display effect of playing a predetermined video segment according to embodiments of the present disclosure.

FIG. 5 illustrates a schematic diagram of an example display effect of playing another predetermined video segment according to embodiments of the present disclosure.

FIG. 6 illustrates a schematic diagram of an example display effect of playing a video corresponding to a cover according to embodiments of the present disclosure.

FIG. 7 illustrates a structural diagram of an apparatus for video playback based on virtual reality according to embodiments of the present disclosure.

### DETAILED DESCRIPTION

Embodiments of the present disclosure will be described in more detail below with reference to the accompanying drawings. It should be noted that the embodiments and the features in the embodiments may be combined with each other without conflict.

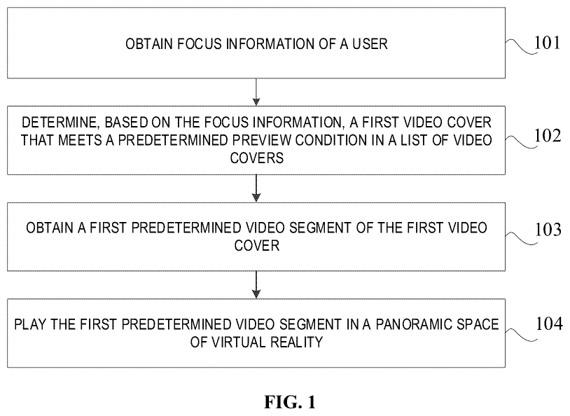

To solve the technical problem that the selection time spent by users for video-on-demand is increased in prior art, which affects the operational cost of the users during the virtual reality experience, the present embodiments provide a method of video playback based on virtual reality. As shown in FIG. 1, the method may be applied at the VR device side, and include the following:

Step 101: obtaining focus information of a user.

In the process of the user using the VR device, the video-on-demand may be implemented through focus positioning. In particular, the user may control a movement of the focus via gestures, handle rays, and the like. On the side of VR device, the focus information of the user may be obtained. The focus information may contain position information of the user's focus in a virtual reality display space.

Step 102: determine, based on the focus information, a first video cover that meets a predetermined preview condition in a list of video covers.

The list of video covers includes at least one video cover. The video cover may help the user determine a corresponding video. The User may subsequently select to play the video corresponding to the video cover and experience the respective VR video effect.

The predetermined preview condition is used to determine whether to trigger the play back of a predetermined video segment of a target video cover, which may be set in advance according to the actual demand. The first video cover is the target video cover, which may be determined based on the focus information of the user combined with the predetermined preview condition. For example, when the user's focus is directed to a video cover A in the list of video covers through an interactive means, such as, a gesture a handle ray, and the like, the video cover A may be determined to be the target video cover that meets the predetermined preview condition.

In the embodiment, for the video covers in the list, a respective video segment corresponding to each of the video covers may be configured in advance to introduce a specific video-related content corresponding to the video cover and the VR effect after the video is played, etc. And a corresponding mapping relationship is established and saved, i.e., a predetermined video segment corresponding to each video cover.

Step 103: obtaining a first predetermined video segment of the first video cover.

The first predetermined video segment is the predetermined video segment mapped to the first video cover.

For example, by querying the saved mapping relationship, the predetermined video segment corresponding to the video cover that meets the predetermined preview condition is obtained. The predetermined video segment may be obtained by downloading from a server or obtained locally (e.g., configured or downloaded locally in advance).

Step 104: playing the first predetermined video segment in a panoramic space of virtual reality.

For the embodiment, the panoramic space of virtual reality may be a three-dimensional space, where the user may watch the predetermined video segment as if he or she were in the virtual environment, which brings a more realistic experience to the user. Compared with a traditional video preview method (e.g., a preview content related to the video is displayed in a two-dimensional plane dimension only in the area of the video cover on the video website), the method provided by application of the embodiments can not only help the user to understand the specific video content corresponding to the video cover, but also allow the user to directly and accurately know the VR effect after playback of the video. The preview content related to the video traditionally displayed in two-dimensional plane dimension cannot show the three-dimensional VR effects very well, potentially misleading the user in selection of video-on-demand.

Therefore, the embodiments can provide more reference information during the user selects the contents of the list of video covers. Specifically, on the VR device side, a video cover that meets the predetermined preview condition can be determined in the list of video covers based on the user's focus, and then the predetermined video segment of the video cover is played in the panoramic space of virtual reality. By applying the technical solution of the embodiments, the selection time spent by the user for video-on-demand when using the VR device can be reduced, which saves the operational cost for the user during the VR experience, thereby improving the efficiency of the user to watch the video that meet his or her need.

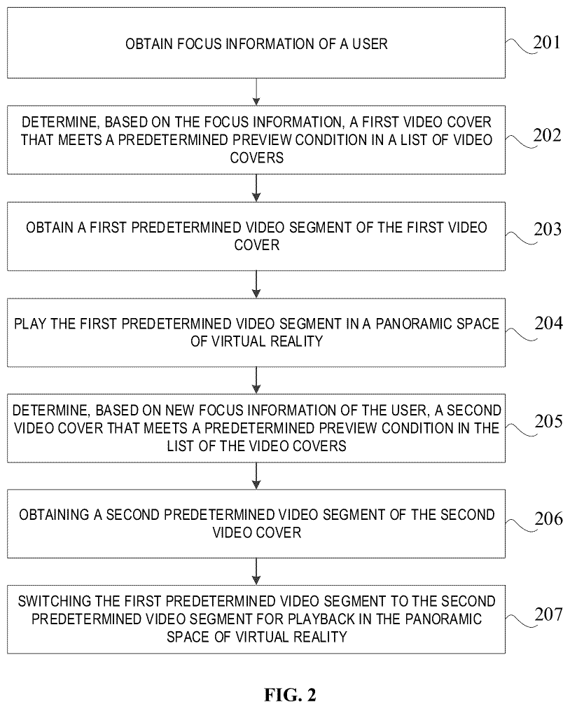

Further, as details and extension of the above embodiments, and in order to completely illustrate the specific implementation process of the method of the embodiments, the present embodiment provides a specific method as shown in FIG. 2, which comprises:

Step 201: obtaining focus information of a user.

Step 202: determining a first video cover in a list of video covers that meets a predetermined preview condition based on the focus information of the user.

In the embodiment, the video cover to which the focus information of the user is directed may be determined as the video cover that meets the predetermined preview condition. However, this would easily lead to misjudgment, for example, instead of directing to the video cover, the user's focus is merely passing by it. To reduce such misjudgment, optionally, step 202 may specifically include: determining a video cover on which the focus information of the user is hovering for a period greater than or equal to a predetermined threshold period (which may be preconfigured according to actual needs) as the first video cover that meets the predetermined preview condition. For example, a video cover on which the user's focus hovers for a period greater than or equal to a certain threshold (i.e., the video cover that is selected by the moving hover) may be determined as the cover meeting the preview condition, which in turn reduces the resource consumptions caused by the playback of video segments that are not intended by the user and also reduces the interference with the user's video selection.

By way of example, the predetermined video segments of the video covers in the list of video covers may include: a static image carousel of a corresponding video, a silent segment of the video, a thumbnail edited version of the video, or a sound segment of the video. For example, the carousel of static image, or a preconfigured segment of the video without sound, a thumbnail edited version of the video, or a preconfigured segment of the video with sound.

Step 203: obtaining a first predetermined video segment of the first video cover.

For this embodiment, if the predetermined video segment needs to be downloaded from the server. considering that network bandwidth and other reasons may cause the problem of not being able to play the corresponding predetermined video segment in time, optionally, for this embodiment, the predetermined video segments of the video covers in the list of video covers may be downloaded in advance in response to a predetermined network bandwidth condition being met (which is used to determine whether the network bandwidth is good). By this optional way of downloading in advance, the waiting time for playing the predetermined video segment can be reduced, and the waiting time for switching between predetermined video segments can also be reduced. The targeted pre-configuration technology strategies can be achieved, which is beneficial in utilizing the network bandwidth at the suitable time, relieving the bandwidth pressure while ensuring stability of the user's interaction for instant selection and acquisition.

Step 204: playing the first predetermined video segment in a panoramic space of virtual reality.

In the embodiments, the predetermined video segment may be a preview content that is prepared in advance and of the kind that better matches the content of the cover, for example, static image switching, positioning of a highly popular segment, automatic skipping of intros, whether to include sound attributes at the same time, and so on. In order to display a video-related content more accurately, optionally, the predetermined video segments of the video covers in the list of video covers may be determined based on information of the current user (such as, user identity, location, the group to which the user belongs, etc.), where for the same video cover, different users have their corresponding predetermined video segments.

The embodiments allow a flexible configuration of the appearance of contents that the user is more interested in by differentiation of preview content configuration of content categories, to maximize the efficiency of user information discrimination and screening. For example, for the current user, segments with high bullet comment penetration are displayed, or alternatively, the climax segments of a story content are displayed, etc. By such a way of playing personalized predetermined video segments for different users, a more accurate display of video-related content can be achieved, which reduces the selection time spent by the user in the video-on-demand process, and improves the efficiency of users' video selection.

By way of example, when playing within the panoramic space of virtual reality, the panoramic content of the first predetermined video segment may be played throughout the entire panoramic space or, optionally. Step 204 may further include: playing a panoramic content of the first predetermined video segment within a predetermined range (such as, a specific small range as compared to the entire panoramic space, which may be preconfigured according to actual needs). Additionally, depending on actual needs, it may switch between 2D/3D content playback, such as movies, mid-length videos, short videos, etc.

Further, after Step 204, the embodiment may further include: in response to a video playback instruction from the use for the first video cover, switching the first predetermined video segment to a video content corresponding to the first video cover for playback in the panoramic space of virtual reality.

For example, when the user's focus is directed to the cover A by using a gesture or a handle ray, the panoramic space behind the cover may transition to the predetermined segment al of the video content mapped to this cover. If the user further “clicks” on and select the cover A by some interactive means, such as, a gesture or a handle ray, it formally enters the play back state of the video content, and the play back will refresh the progress of the original segment to restart.

After Step 204, it may further include: in response to new focus information of the user moving out of a range of the first video cover, canceling the playback of the first predetermined video segment in the panoramic space of virtual reality. For example, when the user's focus is on the cover B without “clicking” a confirm button, if the user moves the focus out of the cover B (e.g., moving to a blank area within the panoramic view other than covers. TAB label, and function buttons), the panoramic content behind the cover may transitionally disappear. This reduces interference with the user's video-on-demand selection.

In specific applications, the users may select more other video covers in the list of video covers for preview of video-related contents. Specifically, the process shown in Steps 205 to 207 may be performed.

Step 205: determining, based on new focus information of the user, a second video cover that meets a predetermined preview condition in the list of the video covers.

The second video cover is different from the first video cover, that is, the second video cover is the other video cover in the list of video covers than the first video cover determined in Step 202.

For example, after the user's focus is directed to the cover A via a gesture or a handle ray, a preconfigured segment al of the video content mapped to the cover A is played in the panoramic space. After the user knows the content of a1, the focus is shifted to the cover B via the interactive means, such as, a gesture, a handle ray, and so on.

Step 206: obtaining a second predetermined video segment of the second video cover.

The second predetermined video segment is a predetermined video segment mapped to the second video cover.

If the predetermined video segment needs to be downloaded from the server, based on the optional way of Step 203, the second predetermined video segment may be downloaded in advance in response to the predetermined network bandwidth condition being met. In this way, the waiting time when switching between predetermined video segments is reduced, and the display efficiency of switching video segments is improved.

Step 207: switching the first predetermined video segment to the second predetermined video segment for play back in the panoramic space of virtual reality.

This in turn allows the user to promptly understand the predetermined segment of the video content of the video cover that the new focus is directed to.

In practical applications, when the user switch rapidly between multiple contents in the list of video covers, it is likely to bring about the problem of flickering due to a wide range of switching of the background picture, which will lead to the user's viewing discomfort if such a situation is serious. To address this issue, optionally. Step 207 of this embodiment may specifically include: switching the first predetermined video segment to the second predetermined video segment through a first transition animation (which is preconfigured according to actual needs) for playback in the panoramic space of virtual reality.

For this optional way, the two preview contents before and after may be switched through a suitable transition animation, which is beneficial to the user during content selection without excessively disturbing the user's primary searching path, and the supplemental preview image servers as supplemental information for selective consumption. Moreover, it also helps avoid high frequency and rapid flickering of larger screen jumps when the user is searching and viewing multiple contents, which reduces the irritation to the user's eyes.

To better achieve the above objectives, the content of transition animation may be pre-configured in a targeted manner. As an optional way, the first transition animation may be generated based on the first predetermined video segment and/or the second predetermined video segment. For example, based on the contents of the two predetermined video segments a1 and b1, an animation content that can be well transitioned is preproduced. As an example, the two videos corresponding to a1 and b1 are in the form of a serial including a first episode and a second episode, and the transition animation may be produced as an animation that guides to watch the content of the next episode. As another example, the video segment corresponding to a1 is a video of experiencing a roller coaster, while the video segment corresponding to b1 is a video of experiencing a carousel, in this case, the transition animation may be produced as an animation that goes from the facility side of the roller coaster to the facility site of the carousel. By such an optional way, a smooth transition between the predetermined video segments before and after can be achieved.

As another optional way, the first transition animation may also be generated based on the current user's historical browsing record of the list of the video covers. As an example, the user last watched the video M in the list of video covers, and after the user opens the list of video covers again, and in the process of switching between the two predetermined video segments, the transition animation may be produced as an animation that prompts the user to last watch the record related to the video M. This optional way can help the user quickly locate the target video that needs to be watched, which improves the efficiency of video search.

In this embodiment, the transition animation content may be obtained locally or downloaded from the server. Considering the impact of the network bandwidth, the transition animations between different predetermined video segments may be downloaded in advance when the network bandwidth permits, to ensure that the transition animation can be played in time during switching.

To further improve the user experience and minimize the user's selection time during video-on-demand. optionally, the panorama content may be played automatically upon product launch without waiting for the prior focus operation to determine whether to play. Accordingly, before Step 201, the method may further include: displaying the list of video covers, and playing a third predetermined video segment in the panoramic space of virtual reality, wherein the third predetermined video segment may be a predetermined video segment of a video cover in the lists of the video covers. By way of example, it may be a predetermined video segment of the first video cover in the list of video covers by default, or a predetermined video segment of the last video cover watched by the user during the most recent browsing of the list. Accordingly. Step 204 specifically may include: switching the third predetermined video segment to the first predetermined video segment for playback in the panoramic space of virtual reality.

Similarly, to address the flickering issue due to a wide range of switching of the background picture, optionally, the switching the third predetermined video segment to the first predetermined video segment for playback in the panoramic space of virtual reality may specifically include: switching the third predetermined video segment to the first predetermined video segment through a second transition animation (which may be preconfigured according to actual needs) for playback in the panoramic space of virtual reality.

For this optional way, the two preview contents before and after may be switched through a suitable transition animation, which is beneficial to the user during content selection without excessively disturbing the user's primary searching path, and the supplemental preview image servers as supplemental information for selective consumption. Moreover, it also helps avoid high frequency and rapid flickering of larger screen jumps when the user is searching and viewing multiple contents, which reduces the irritation to the user's eyes.

To better achieve the above objectives, the content of transition animation may be pre-configured in a targeted manner. As an optional way, the second transition animation may be generated based on the third predetermined video segment and/or the first predetermined video segment. For example, based on the contents of the two predetermined video segments m1 and n1, an animation content that can be well transitioned is preproduced. As an example, the video segment corresponding to m1 is a video of the outdoor entertainment program outside a castle, while the video segment corresponding to n1 is a video of the indoor entertainment program inside the castle, in this case, the transition animation may be produced as an animation of walking into the castle from the outdoor, or the like. By such an optional way, a smooth transition between the predetermined video segments before and after can be achieved.

As another optional way, the second transition animation may also be generated based on the current user's historical browsing record of the list of the video covers. As an example, the transition animation may be produced as an animation that prompts the user for the number of historical views of the video content of the video cover on which the current focus is hover. This optional way can help the user quickly locate the target video that needs to be watched based on the historical number of times each video has been watched, such as, a video that has not been watched in history, which improves the efficiency of video search.

To illustrate the specific implementation process of each of the above embodiments, the following application examples are given by applying the method of the embodiments, but are not limited thereto:

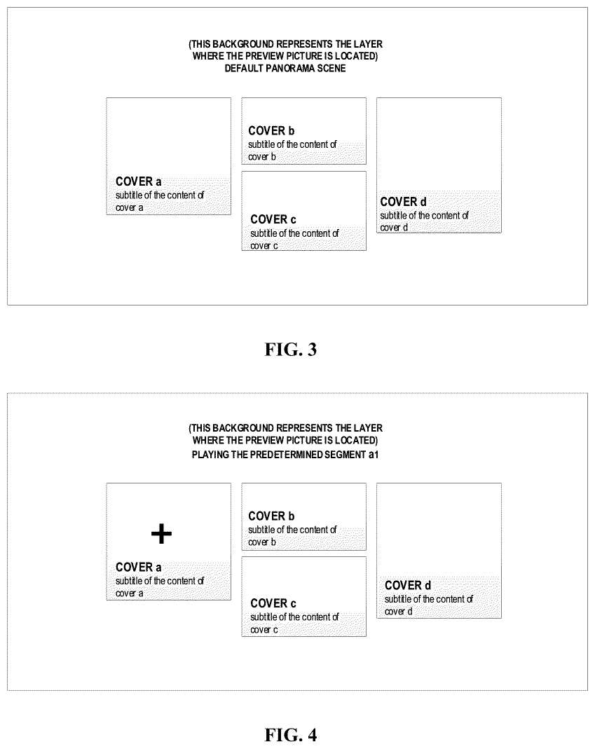

For example, under a normal network condition, when a user enters the product, a list of video covers is presented within the user's field of view, and the list contains covers a, b, c, d, etc., as shown in FIG. 3. The background of the cover list is the panoramic space of virtual reality, which may show the three-dimensional visual effects.

When the user focuses on the cover a via an interactive means, such as, a gesture, a handle ray, and the like, the panoramic space behind the cover list transitionally switch to a predetermined segment a1 of the video content mapped to the cover a in a short period of time, such as, a carousel of static images, a predetermined segment of the video without sound, a thumbnail edited version of the video, a predetermined segment of the video with sound, and so on. As shown in FIG. 4, the black cross may represent the user's focus, and when the focus hovers over the cover a, the predetermined segment a1 is played in the panoramic space behind the list. The segment may also be looped automatically after completing one cycle loop of segment playback.

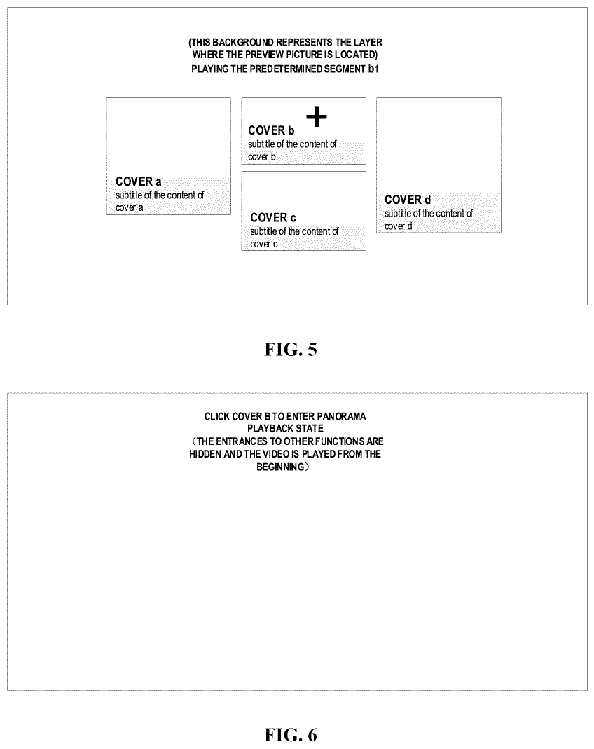

Subsequently, when the user continues to manipulate the focus via the interactive means (such as, a gesture, a handle ray, and the like) to move the focus from the cover a to the cover b, the picture of the panoramic space behind the cover list transitions to a panoramic segment b1 of the video content mapped to the cover b through a specific animation, such as, a carousel of static images, a predetermined segment of the video without sound, a thumbnail edited version of the video, a predetermined segment of the video with sound, and so on. As shown in FIG. 5, the black cross may represent the user's focus, and when the focus moves and hovers over the cover b, the predetermined segment b1 is played in the panoramic space behind the list. The segment may also be looped automatically after completing one cycle loop of segment playback.

If the user “clicks” to select this cover b via some interactive means, such as, a gesture, a handle ray and the like, it will formally enter the play back state of the video content, and the playback will refresh the progress of the original segment and restart. The original cover list containing the covers a, b, etc., is hidden to ensure an immersive sense of content consumption. As shown in FIG. 6, clicking on the cover b enters the panoramic playback state, while other functional entries are hidden, and the video starts playing from the beginning. The formal play back state is entered.

If the user does not “click” the confirmation button when the focus is over the cover b, but moves the focus out of the cover b (e.g., moving to a blank area within the panoramic view other than covers, TAB label, and function buttons), the panoramic content behind the cover list transitionally disappears.

The solution of the embodiments, on top of the existing presentation logic of content list, by utilizing a ray or other design means, allows the content picture of the recommended content to be displayed more prominently. For example, when the user moves the handle ray to a cover in the recommendation list, the space behind the recommendation list will automatically switch to the panoramic video content mapped to the cover (which is selected by the moving hover). More screening information can be provided as the user selects the contents. The selection time spent by the user for video-on-demand is reduced, and the efficiency of selecting videos by the user is improved.

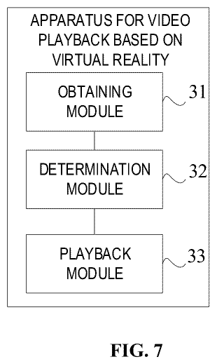

Further, as a specific implementation of the methods shown in FIGS. 1 and 2, the embodiments provide an apparatus of video playback based on virtual reality. As shown in FIG. 7, the apparatus includes: an obtaining module 31, a determination module 32, and a play back module 33.

The obtaining module 31 is configured to obtain focus information of a user;

The determination module 32 is configured to determine, based on the focus information, a first video cover that meets a predetermined preview condition in a list of video covers;

The obtaining module 31 is further configured to obtain a first predetermined video segment of the first video cover;

The playback module 33 is configured to play the first predetermined video segment in a panoramic space of virtual reality.

In specific application scenarios, the determination module 32 is specifically configured to determine a video cover on which the focus information is hovering for a period greater than or equal to a predetermined threshold period as the first video cover that meets the predetermined preview condition.

In specific application scenarios, the play back module 33 is further configured to determine, based on new focus information of the user, a second video cover that meets a predetermined preview condition in the list of the video covers, wherein the second video cover is different from the first video cover; obtain a second predetermined video segment of the second video cover; switch the first predetermined video segment to the second predetermined video segment for play back in the panoramic space of virtual reality.

In specific application scenarios, the play back module 33 is further specifically configured to switch the first predetermined video segment to the second predetermined video segment through a first transition animation for playback in the panoramic space of virtual reality.

In specific application scenarios, optionally, the first transition animation is generated based on the first predetermined video segment and/or the second predetermined video segment.

In specific application scenarios, optionally, the first transition animation is generated based on a current user's historical browsing record of the list of the video covers.

In specific application scenarios, the play back module 33 is further configured to display the list of the video covers, and play a third predetermined video segment in the panoramic space of virtual reality, wherein the third predetermined video segment is a predetermined video segment of a video cover in the lists of the video covers.

In specific application scenarios, the play back module 33 is further specifically configured to switch the third predetermined video segment to the first predetermined video segment for play back in the panoramic space of virtual reality.

In specific application scenarios, the playback module 33 is further specifically configured to switch the third predetermined video segment to the first predetermined video segment through a second transition animation for playback in the panoramic space of virtual reality.

In specific application scenarios, optionally, the second transition animation is generated based on the third predetermined video segment and/or the first predetermined video segment.

In specific application scenarios, optionally, the second transition animation is generated based on a current user's historical browsing record of the list of the video covers.

In specific application scenarios, optionally, a predetermined video segment of a video cover in the list of the video covers comprises: a static image carousel of a corresponding video, a silent segment of the video, a thumbnail edited version of the video, or a sound segment of the video.

In specific application scenarios, optionally, a predetermined video segment of a video cover in the list of the video covers is downloaded in advance in response to a predetermined network bandwidth condition being met.

In specific application scenarios, optionally, a predetermined video segment of a video cover in the list of the video covers is determined based on information of the current user, wherein for the same video cover, different users have respective corresponding predetermined video segments.

In specific application scenarios, the playback module 33 is specifically configured to play a panoramic content of the first predetermined video segment within a predetermined range.

In specific application scenarios, the playback module 33 is further configured to, in response to a video playback instruction from the use for the first video cover, switching the first predetermined video segment to a video content corresponding to the first video cover for playback in the panoramic space of virtual reality.

In a specific application scenario, the playback module 33 may be further configured to after playing the first predetermined video segment in the panoramic space of virtual reality, in response to new focus information of the user moving out of a range of the first video cover, cancel the playback of the first predetermined video segment in the panoramic space of virtual reality.

It should be noted that other corresponding descriptions of each functional unit involved in the apparatus of video playback based on virtual reality provided by the embodiments may refer to the corresponding descriptions in FIGS. 1 and 2, which will not be repeated herein.

According to the methods shown in FIGS. 1 and 2, the embodiments also provide a computer-readable storage medium having a computer program stored thereon, which, when executed by a processor, carries out the above-described method of video playback based on virtual reality as shown in FIGS. 1 and 2.

With this understanding, the technical solution of the present disclosure may be embodied in the form of software products. The software products may be stored in a non-volatile storage medium (such as, a CD-ROM, USB drive, removable hard disk, and so on) and include several instructions that cause a computer device (such as, a personal computer, a server, a network device, and so on) to perform the methods of various embodiments of the present disclosure.

Based on the methods as shown in FIGS. 1 and 2, and the embodiments of the virtual reality apparatus as shown in FIG. 7, in order to achieve the above objectives, the embodiments also provide an electronic device, which may specifically be a virtual reality device, tablet, smartphone, or other network device. This device includes a storage medium and a processor; the storage medium is configured to store a computer program; the processor is configured to execute the computer program to carry out the method of video playback based on virtual reality as shown in FIGS. 1 and 2.

Optionally, the above-described physical device may further include a user interface, a network interface, a camera, radio frequency (RF) circuitry, sensors, audio circuitry, Wi-Fi module, and so on. The user interface may include a display, an input unit, such as a keyboard, and optionally, the user interface may further include a USB interface, a card reader interface, and so on. The network interface may optionally include a standard wired interface, a wireless interface (such as, a Wi-Fi interface), and so on.

Those skilled in the art should understand that the above structure of the physical device provided in the embodiments does not limit the physical device, which may include more or fewer components, or combine certain components, or have a different arrangement of components.

The storage medium may further include an operating system and a network communication module. The operating system is a program that manages hardware and software resources of the above-described physical device, which supports the operation of information processing programs and other software and/or programs. The network communication module is used to achieve communications between various components inside the storage medium, as well as communications between other hardware and software in the information processing physical device.

From the above descriptions of the embodiments, those skilled in the art should clearly understand that the present disclosure can be implemented by means of a software plus the necessary general hardware platform or implemented in hardware. By applying the solutions of the embodiments, more reference information can be provided during the user selects the contents of the list of video covers, which helps the user to promptly understand the specific video-related content corresponding to the video cover and the VR effect after the video is played. This can reduce the selection time spent by the user for video-on-demand when using the virtual reality device, and save the operational cost for the user during the VR experience, thereby improving the efficiency of the user to watch the video that meets his or her need.

It should be noted that the relational terms such as “first” and “second” are merely used herein to distinguish one entity or operation from another, and do not necessarily require or imply any such actual relationship or order between these entities or operations. Moreover, the terms “comprise”, “include”, or any other variants thereof are intended to encompass non-exclusive inclusion, such that a process, method, item, or device comprising a series of elements includes not only those elements, but also other elements not expressly listed, or includes elements inherent to such process, method, item, or device. Without further limitation, an element defined by the phrase “comprise a . . . ” does not preclude the presence of additional identical elements in the process, method, item, or device that comprises the element.

The foregoing are only specific embodiments of the present disclosure, which enable those skilled in the art to understand or implement the present disclosure. Various modifications to these embodiments will be apparent to those skilled in the art, and the general principles defined herein may be implemented in other embodiments without departing from the spirit or scope of the present disclosure. Therefore, the present disclosure will not be limited to these embodiments but will conform to the broadest scope consistent with the principles and novel features disclosed herein.

1. A method of video playback based on virtual reality, comprising:
obtaining focus information of a user;
determining, based on the focus information, a first video cover that meets a predetermined preview condition in a list of video covers;
obtaining a first predetermined video segment of the first video cover;
playing the first predetermined video segment in a panoramic space of virtual reality.

2. The method of claim 1, wherein the determining, based on the focus information, a first video cover that meets a predetermined preview condition in a list of video covers comprises:
determining a video cover on which the focus information is hovering for a period greater than or equal to a predetermined threshold period as the first video cover that meets the predetermined preview condition.

3. The method of claim 1, wherein the method further comprises: after the playing the first predetermined video segment in a panoramic space of virtual reality,
determining, based on new focus information of the user, a second video cover that meets a predetermined preview condition in the list of the video covers, wherein the second video cover is different from the first video cover;
obtaining a second predetermined video segment of the second video cover;
switching the first predetermined video segment to the second predetermined video segment for playback in the panoramic space of virtual reality.

4. The method of claim 3, wherein the switching the first predetermined video segment to the second predetermined video segment for playback in the panoramic space of virtual reality comprises:
switching the first predetermined video segment to the second predetermined video segment through a first transition animation for playback in the panoramic space of virtual reality.

5. The method of claim 4, wherein the first transition animation is generated based on the first predetermined video segment and/or the second predetermined video segment.

6. The method of claim 4, wherein the first transition animation is generated based on a current user's historical browsing record of the list of the video covers.

7. The method of claim 1, wherein the method further comprises: before obtaining the focus information of the user,
displaying the list of the video covers, and playing a third predetermined video segment in the panoramic space of virtual reality, wherein the third predetermined video segment is a predetermined video segment of a video cover in the lists of the video covers.

8. The method of claim 7, wherein the playing the first predetermined video segment in a panoramic space of virtual reality comprises:
switching the third predetermined video segment to the first predetermined video segment for playback in the panoramic space of virtual reality.

9. The method of claim 8, wherein the switching the third predetermined video segment to the first predetermined video segment for playback in the panoramic space of virtual reality comprises:
switching the third predetermined video segment to the first predetermined video segment through a second transition animation for playback in the panoramic space of virtual reality.

10. The method of claim 9, wherein the second transition animation is generated based on the third predetermined video segment and/or the first predetermined video segment.

11. The method of claim 9, wherein the second transition animation is generated based on a current user's historical browsing record of the list of the video covers.

12. The method of claim 1, wherein a predetermined video segment of a video cover in the list of the video covers comprises: a static image carousel of a corresponding video, a silent segment of the video, a thumbnail edited version of the video, or a sound segment of the video.

13. The method of claim 1, wherein a predetermined video segment of a video cover in the list of the video covers is downloaded in advance in response to a predetermined network bandwidth condition being met.

14. The method of claim 1, wherein a predetermined video segment of a video cover in the list of the video covers is determined based on information of the current user, wherein for the same video cover, different users have respective corresponding predetermined video segments.

15. The method of claim 1, wherein the playing the first predetermined video segment in a panoramic space of virtual reality comprises:
playing a panoramic content of the first predetermined video segment within a predetermined range.

16. The method of claim 1, wherein the method further comprises: after the playing the first predetermined video segment in a panoramic space of virtual reality,
in response to a video playback instruction from the use for the first video cover, switching the first predetermined video segment to a video content corresponding to the first video cover for playback in the panoramic space of virtual reality.

17. The method of claim 1, wherein the method further comprises: after the playing the first predetermined video segment in a panoramic space of virtual reality,
in response to new focus information of the user moving out of a range of the first video cover, canceling the playback of the first predetermined video segment in the panoramic space of virtual reality.

18. (canceled)

19. A non-transitory computer-readable storage medium having a computer program stored thereon, wherein the computer program, when executed by a processor, carries out a method comprising:
obtaining focus information of a user;
determining, based on the focus information, a first video cover that meets a predetermined preview condition in a list of video covers;
obtaining a first predetermined video segment of the first video cover;
playing the first predetermined video segment in a panoramic space of virtual reality.

20. An electronic device, comprising a storage medium, a processor, and a computer program stored on the storage medium and runnable on the processor, wherein the processor, when executing the computer program, carries out a method comprising:
obtaining focus information of a user;
determining, based on the focus information, a first video cover that meets a predetermined preview condition in a list of video covers;
obtaining a first predetermined video segment of the first video cover;
playing the first predetermined video segment in a panoramic space of virtual reality.

21. The non-transitory computer-readable storage medium, wherein the determining, based on the focus information, a first video cover that meets a predetermined preview condition in a list of video covers comprises:
determining a video cover on which the focus information is hovering for a period greater than or equal to a predetermined threshold period as the first video cover that meets the predetermined preview condition.
